(19) United States
(12) Patent Application Publication
(10) Pub. No.: US 2025/0168739 A1
(43) Pub. Date: May 22, 2025

(54) CONDITIONAL CONFIGURATION INFORMATION PROCESSING METHOD AND APPARATUS, AND TERMINAL

(71) Applicant: VIVO MOBILE COMMUNICATION CO., LTD., Dongguan (CN)

(72) Inventors: Yangyang WANG, Dongguan (CN); Wei BAO, Dongguan (CN); Xuanbing LIU, Dongguan (CN)

(73) Assignee: VIVO MOBILE COMMUNICATION CO., LTD., Dongguan (CN)

(21) Appl. No.: 19/033,377

(22) Filed: Jan. 21, 2025

Related U.S. Application Data
(63) Continuation of application No. PCT/CN2023/104346, filed on Jun. 30, 2023.

(30) Foreign Application Priority Data
Jul. 21, 2022 (CN) 202210865692.0

(51) Int. Cl. H04W 36/36; H04W 76/27

(52) U.S. Cl. CPC H04W 36/362; H04W 76/27

(57) ABSTRACT

This application provides a conditional configuration information processing method and apparatus, and a terminal. The conditional configuration information processing method includes: during execution of Conditional Primary Secondary Cell Group Cell Addition/Change (CPAC), a terminal performs a first operation. The first operation includes at least one of the following: continuing to evaluate or stopping evaluating an execution condition associated with a candidate cell included in first conditional configuration information; or continuing to evaluate or stopping evaluating an execution condition associated with a candidate cell included in second conditional configuration information. The first conditional configuration information includes CPAC configuration information or subsequent CPAC configuration information. The second conditional configuration information includes Conditional Handover (CHO) configuration information or CHO configuration information with CPAC configuration information.

### CROSS-REFERENCE TO RELATED APPLICATIONS

This application is a continuation of International Application No. PCT/CN 2023/10 4346, filed on Jun. 30, 2023, which claims priority to Chinese Patent Application No. 202210865692.0, filed in China on Jul. 21, 2022. The entire contents of each of the above-referenced applications are expressly incorporated herein by reference.

### TECHNICAL FIELD

This application pertains to the field of communication technologies, and specifically, to a conditional configuration information processing method and apparatus, and a terminal.

### BACKGROUND

In a related technology, when executing Conditional Primary Secondary Cell Group Cell Addition/Change (Conditional PSCell Addition/Change (CPAC)), User Equipment (UE) does not need to continue to evaluate an execution condition of another candidate Primary Secondary Cell Group Cell (PSCell); and provided that CPAC succeeds, the UE releases all stored conditional reconfiguration information. However, one studied enhancement direction of CPAC is subsequent CPAC. To be specific, after changing a serving PSCell, the UE does not release a stored conditional configuration related parameter, and may continue to apply the stored related conditional configuration information to execute subsequent Conditional Primary Secondary Cell Group Cell Addition (Conditional PSCell Addition (CPA))/Conditional Primary Secondary Cell Group Cell Change (Conditional PSCell Change (CPC)). Consequently, a behavior of the UE to evaluate the execution condition in the conditional configuration information is not clarified when the UE executes CPAC.

### SUMMARY

Embodiments of this application provide a conditional configuration information processing method and apparatus, and a terminal, so that a problem that a behavior of UE to evaluate an execution condition in conditional configuration information is not clear when UE executes CPAC.

According to a first aspect, a conditional configuration information processing method is provided. The method includes:

During execution of conditional primary secondary cell group cell addition/change CPAC, a terminal performs a first operation, where the first operation includes at least one of the following:
continuing to evaluate or stopping evaluating an execution condition associated with a candidate cell included in first conditional configuration information; and
continuing to evaluate or stopping evaluating an execution condition associated with a candidate cell included in second conditional configuration information, where
the first conditional configuration information includes CPAC configuration information and/or subsequent CPAC configuration information, and the second conditional configuration information includes conditional handover CHO configuration information and/or CHO configuration information with CPAC configuration information.

According to a second aspect, a conditional configuration information processing apparatus is provided and is applied to a terminal. The apparatus includes:
a first processing module, configured to: during execution of conditional primary secondary cell group cell addition/change CPAC, perform a first operation, where the first operation includes at least one of the following:
continuing to evaluate or stopping evaluating an execution condition associated with a candidate cell included in first conditional configuration information; and
continuing to evaluate or stopping evaluating an execution condition associated with a candidate cell included in second conditional configuration information, where
the first conditional configuration information includes CPAC configuration information and/or subsequent CPAC configuration information, and the second conditional configuration information includes conditional handover CHO configuration information and/or CHO configuration information with CPAC configuration information.

According to a third aspect, a terminal is provided. The terminal includes a processor and a memory, the memory stores a program or an instruction that can be run on the processor, and the program or the instruction is executed by the processor to implement steps of the method according to the first aspect.

According to a fourth aspect, a terminal is provided. The terminal includes a processor and a communication interface, and the processor is configured to: during execution of conditional primary secondary cell group cell addition/change CPAC, perform a first operation, where the first operation includes at least one of the following:
continuing to evaluate or stopping evaluating an execution condition associated with a candidate cell included in first conditional configuration information; and
continuing to evaluate or stopping evaluating an execution condition associated with a candidate cell included in second conditional configuration information, where
the first conditional configuration information includes CPAC configuration information and/or subsequent CPAC configuration information, and the second conditional configuration information includes conditional handover CHO configuration information and/or CHO configuration information with CPAC configuration information.

According to a fifth aspect, a readable storage medium is provided. The readable storage medium stores a program or an instruction, and the program or the instruction is executed by a processor to implement steps of the method according to the first aspect.

According to a sixth aspect, a chip is provided. The chip includes a processor and a communication interface, the communication interface is coupled to the processor, and the processor is configured to run a program or an instruction to implement the method according to the first aspect.

According to a seventh aspect, a computer program/program product is provided. The computer program/program product is stored in a storage medium, and the computer program/program product is executed by at least one processor to implement steps of the method according to the first aspect.

In embodiments of this application, during execution of CPAC, the terminal continues to evaluate or stop evaluating the execution condition associated with the candidate cell included in the first conditional configuration information, and/or continues to evaluate or stop evaluating the execution condition associated with the candidate cell included in the second conditional configuration information. This clarifies a behavior of UE to evaluate the execution condition in the conditional configuration information during execution of CPAC.

### BRIEF DESCRIPTION OF DRAWINGS

FIG. 1 is a structural diagram of a communication system to which embodiments of this application can be applied;

FIG. 2 is a schematic diagram corresponding to subsequent CPAC;

FIG. 3 is a schematic flowchart of a conditional configuration information processing method according to an embodiment of this application;

FIG. 4 is a first schematic diagram of a moment at which an execution condition associated with a candidate cell in second conditional configuration information is continuously evaluated during execution of CPAC according to an embodiment of this application;

FIG. 5 is a second schematic diagram of a moment at which an execution condition associated with a candidate cell in second conditional configuration information is continuously evaluated during execution of CPAC according to an embodiment of this application;

FIG. 6 is a third schematic diagram of a moment at which an execution condition associated with a candidate cell in second conditional configuration information is continuously evaluated during execution of CPAC according to an embodiment of this application;

FIG. 7 is a schematic diagram of continuing to evaluate, at a target moment, an execution condition associated with a candidate cell in second conditional configuration information during execution of CPAC according to an embodiment of this application;

FIG. 8 is a schematic diagram of re-evaluating, at a target moment, an execution condition associated with a candidate cell in second conditional configuration information during execution of CPAC according to an embodiment of this application;

FIG. 9 is a schematic diagram of re-evaluating, at a third moment, an execution condition associated with a candidate cell in first conditional configuration information during execution of CPAC according to an embodiment of this application;

FIG. 10 is a schematic diagram of a module of a conditional configuration information processing apparatus according to an embodiment of this application;

FIG. 11 is a structural block diagram of a communication device according to an embodiment of this application; and

FIG. 12 is a structural block diagram of a terminal according to an embodiment of this application.

### DETAILED DESCRIPTION

The following clearly describes technical solutions in embodiments of this application with reference to accompanying drawings in embodiments of this application. Apparently, the described embodiments are some but not all of embodiments of this application. All other embodiments obtained by a person of ordinary skill in the art based on embodiments of this application shall fall within the protection scope of this application.

The terms “first”, “second”, and the like in this specification and the claims of this application are used to distinguish between similar objects instead of describing a specific order or sequence. It should be understood that, the terms used in such a way are interchangeable in proper circumstances, so that embodiments of this application can be implemented in an order other than the order illustrated or described herein. Objects classified by “first” and “second” are usually of a same type, and a quantity of objects is not limited. For example, there may be one or more first objects. In addition, in this specification and the claims, “and/or” represents at least one of connected objects, and the character “/” generally represents an “or” relationship between associated objects.

It should be noted that the technologies described in embodiments of this application are not limited to a Long Term Evolution (LTE)/LTE-Advanced (LTE-A) system, and may also be used in other wireless communication systems such as a Code Division Multiple Access (CDMA) system, a Time Division Multiple Access (TDMA) system, a Frequency Division Multiple Access (FDMA) system, an Orthogonal Frequency Division Multiple Access (OFDMA) system, a Single-carrier Frequency Division Multiple Access (SC-FDMA) system, and another system. The terms “system” and “network” in embodiments of this application may be used interchangeably. The technologies described can be applied to both the systems and the radio technologies mentioned above as well as to other systems and radio technologies. The following describes a New Radio (NR) system for example purposes, and NR terms are used in most of the following descriptions, although these technologies can also be applied to an application other than an NR system application, for example, a 6th Generation (6G) communication system.

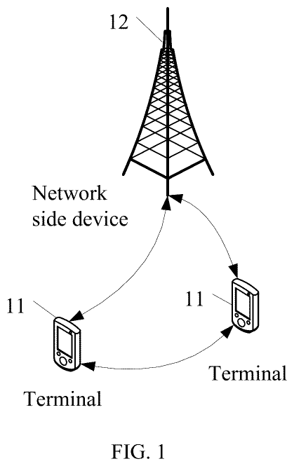

FIG. 1 is a block diagram of a wireless communication system to which embodiments of this application may be applied. The wireless communication system includes a terminal 11 and a network side device 12. The terminal 11 may be a terminal side device, for example, a mobile phone, a tablet personal computer, a laptop computer or a notebook computer, a Personal Digital Assistant (PDA), a palmtop computer, a netbook, an Ultra-Mobile Personal Computer (UMPC), a Mobile Internet Device (MID), an Augmented Reality (AR)/Virtual Reality (VR) device, a robot, a wearable device, Vehicle User Equipment (VUE), Pedestrian User Equipment (PUE), a smart home (a home device with a wireless communication function, for example, a refrigerator, a television, a washing machine, or furniture), a game console, a Personal Computer (PC), a teller machine, or a self-service machine. The wearable device includes a smart watch, a smart band, a smart headset, smart glasses, smart jewelry (a smart bracelet, a smart chain bracelet, a smart ring, a smart necklace, a smart anklet, or a smart chain anklet), a smart wrist strap, smart clothes, and the like. It should be noted that a specific type of the terminal 11 is not limited in embodiments of this application. The network side device 12 may include an access network device or a core network device. The access network device may also be referred to as a radio access network device, a Radio Access Network (RAN), a radio access network function, or a radio access network unit. The access network device may include a base station, a Wireless Local Area Network (WLAN) access node, a Wireless Fidelity (Wi-Fi) node, or the like. The base station may be referred to as a NodeB, an Evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmission Reception Point (TRP), or another appropriate term in the art. Provided that same technical effect is achieved, the base station is not limited to a specified technical term. It should be noted that, in embodiments of this application, only a base station in an NR system is used as an example, but a specific type of the base station is not limited.

To enable a person skilled in the art to better understand embodiments of this application, the following descriptions are provided first.

### 1. Conditional Handover (CHO).

Conditional handover is defined as handover performed when one or more handover execution conditions are met. Provided that a CHO configuration is received, UE starts to evaluate the execution condition, and provided that handover starts to be performed, the UE stops the evaluation.

### Principle of CHO:

The CHO configuration includes a configuration, of a CHO candidate cell, generated by a candidate NR NodeB (gNB) and an execution condition generated by a source gNB.

One execution condition may include one or two trigger conditions (a CHO event A3/A5). For one candidate cell, only a Reference Signal (RS) type and a maximum of two different trigger quantities (for example, a Reference Signal Received Power (RSRP) and a Reference Signal Received Quality (RSRQ), a Signal-to-Noise and Interference Ratio (SINR)) may be configured at the same time.

Before any CHO execution condition is met, provided that a Handover (HO) command is received, the UE executes an HO procedure regardless of any previously received CHO configuration.

When CHO is executed, that is, when the UE starts to synchronize with a target cell, the UE does not perform monitoring in a source cell.

### 2. Dual Connectivity (DC).

Dual connectivity means that a network provides resources of two network nodes/base stations (access network elements) for the UE, one network node is referred to as a Master Node (MN) and the other is referred to as a Secondary Node (SN). Each network node may use one cell to provide a service for the UE; or may use a Carrier Aggregation (CA) technology, that is, a plurality of serving cells controlled by the node are configured for the UE. One or more cells controlled by one node form a Cell Group (CG). The master node MN controls a Master Cell Group (MCG), and a secondary node SN controls a Secondary Cell Group (SCG). Each cell group includes one Special Cell (SpCell) and M Secondary Cell (Scell). In NR, a current value of M is [0, 31], and may be subsequently extended. In the MCG, a special cell is referred to as a Primary Cell (PCell), and in the SCG, a special cell is referred to as a Primary Secondary Cell Group Cell (PSCell).

In the NR, if the UE applies an NW-provided SCG configuration including a synchronous reconfiguration indication (ReconfigurationWithSync IE), and the UE successfully completes RACH in a candidate/target PSCell, PSCell change is successfully performed for the UE.

### 3. Conditional Primary Secondary Cell Group Cell Addition/Change (Conditional PSCell Addition/Change (CPAC)).

A definition of CPAC is that when the execution condition is met, the UE performs PSCell addition/change. When receiving a CPAC configuration, the UE starts to evaluate the execution condition. For CPA, provided that PSCell addition or PCell change is triggered; and for CPC, provided that PSCell change or PCell change is triggered, the UE stops evaluating the execution condition.

CPAC is applicable to the following principles:

The CPAC configuration includes configuration information of the CPAC candidate PSCell(s), and execution conditions, and may include an MCG configuration. When CPAC is triggered, the CPAC configuration is applied.

One execution condition may include one or two trigger conditions (CondEvents). For one candidate PSCell, the CPA execution condition may correspond to only one RS type and a maximum of two trigger quantities (for example, an RSRP and an RSRQ, or an RSRP and an SINR).

Before the CPAC execution condition is met, provided that a PSCell addition command (for CPA)/PSCell change command (for CPC) or a PCell change command (for CPAC) is received, the UE performs the PSCell addition/change step or the PCell change step, regardless of any previously received CPAC configuration. Provided that the PSCell addition/change or PCell change step is successfully completed, the UE releases the stored CPAC configuration.

When CPAC is executed, the UE is not required to continue to evaluate an execution condition of another candidate PSCell.

Provided that the CPAC step is successfully performed, the UE releases all stored conditions for reconfiguration.

For CPA, an event A4 (where quality of a neighboring cell is higher than a threshold) and an event B1 (where quality of an inter-RAT neighboring cell is higher than a threshold) may be used as execution conditions of CPA, and use one or two measurement identifiers (measurement ID); SN initiated CPC may use an event A3 (where quality of a conditional reconfiguration candidate neighboring cell is higher than that of a primary (SpCell) cell PCell/PSCell) or an event A5 (quality of a primary (SpCell) cell is lower than a threshold 1) as an execution condition; and MN initiated CPC may use an event A4/B1 as an execution condition. Each measurement identifier corresponds to one measurement event.

### 4. Evaluation of a Conditional Reconfiguration.

If for one candidate cell, all measurement of the candidate cell after layer 3 filtering taken during corresponding time to trigger meets one event in events associated with an execution condition corresponding to the candidate cell (namely, an entry condition of an event (condEventId) corresponding to one Measurement Identifier (measld) in an execution condition included in the conditional configuration), it is considered that the UE meets the event associated with the measurement identifier (measId).

If for one candidate cell, all measurement filtered by the candidate cell through a layer 3 meets an exit condition of one event (namely, an event (condEventId) corresponding to one measId in an execution condition included in the conditional configuration) in events associated with an execution condition corresponding to the candidate cell within time to trigger, it is considered that the UE does not meet the exit condition associated with the event associated with the measurement identifier (measId).

If a target candidate cell of the UE meets events corresponding to all measurement identifiers included in the conditional configuration, it is considered that the target candidate cell is a trigger cell, and the UE may perform conditional reconfiguration to the trigger cell.

Current events available for the conditional reconfiguration include as follows:

In a current NR protocol, as listed in Table 1, the following several condition events are used for conditional configuration.

TABLE 1

| Event | Event description | Determining standard |
|---|---|---|
| CondEvent A3 | Quality of a conditional | Entry condition: |
| | reconfiguration candidate | Mn + Ofn + Ocn − Hys > Mp + Ofp + |
| | neighboring cell is higher than | Ocp + Off |
| | that of a primary (SpCell) cell | Exit condition: |
| | PCell/PSCell | Mn + Ofn + Ocn + Hys < Mp + Ofp + |
| | | Ocp + Off |
| CondEvent A4 | Quality of a conditional | Entry condition: Mn + Ofn + Ocn − Hys > |
| | reconfiguration neighboring | Thresh |
| | cell is higher than a threshold | Exit condition: Mn + Ofn + Ocn + Hys < |
| | | Thresh |
| CondEvent A5 | Quality of a primary (SpCell) | Entry condition: Mp + Hys < Thresh1 |
| | cell is lower than a threshold | Mn + Ofn + Ocn − Hys > Thresh2 |
| | 1; and | Exit condition: Mp − Hys > Thresh1 |
| | quality of a conditional | Mn + Ofn + Ocn + Hys < Thresh2 |
| | reconfiguration candidate | |
| | neighboring cell is higher than | |
| | a threshold 2 | |

In a current LTE protocol, the following several condition events are used for conditional configuration, as shown in Table 2:

TABLE 2

| Event | Event description | Determining standard |
|---|---|---|
| CondEvent B1 | Quality of an inter- | Entry condition: Mn + Ofn + |
| | RAT neighboring | Ocn − Hys > Thresh |
| | cell is higher than a | Exit condition: Mn + Ofn + |
| | threshold | Ocn + Hys < Thresh |

Mn is a measurement result of a neighboring cell, and no offset is considered.

Mp is a measurement result of an SpCell, and no offset is considered.

Ofn is an offset of a neighboring cell measurement event, and Ocn is a specific offset of a neighboring cell. Both Ofn and Ocn are configured by RRC; and if Ofn and Ocn are not configured by the RRC, Ofn and Ocn are set to 0.

Ofp is an offset of a primary cell measurement event, and Ocp is a specific offset of a primary cell. Both Ofp and Ocp are configured by RRC; and if Ofp and Ocp are not configured, Ofp and Ocp are set to 0.

Hys is a delay parameter of this event, and is configured by RRC. A value range is [0, 30], and an actual value is a configuration value*0.5 dB.

Off is an offset parameter of this event (namely, an a3 threshold (a3-Offset) defined in a 5GNR report configuration (reportConfigNR) of this event).

Thresh is a threshold parameter of this event (namely, a threshold defined in reportConfigNR of this event).

In a case of an RSRP, Mn and Mp are represented in dBm; or in a case of an RSRQ and an RS-SINR, Mn and Mp are represented in dB. Ofn, Ocn, Ofp, Ocp, Hys, and Off are represented in dB, and Thresh is represented in a same unit as Mn.

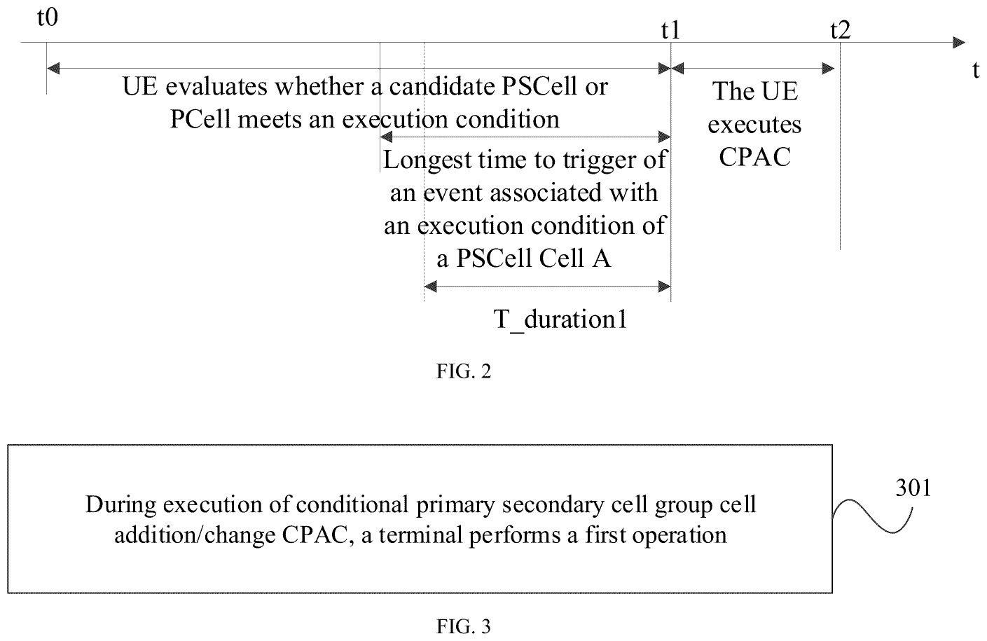

In a related technology, a studied enhancement direction of CPAC is subsequent CPAC. To be specific, after changing a serving PSCell, the UE does not release a stored conditional reconfiguration related parameter, and may continue to apply the stored related configuration parameter to execute subsequent CPA/CPC. As shown in FIG. 2, when CPAC configuration information is received at a moment t0, and a candidate PSCell Cell A meets an execution condition at a moment t1, the UE may execute CPA/CPC, to change a serving cell to the Cell A or add the serving cell Cell A.

For subsequent CPAC, it is not clarified whether the UE needs to continue to evaluate an execution condition of another candidate PSCell when CPAC is executed. If the UE needs to continue to perform evaluation, because cell quality of a candidate PSCell Cell B already meets an entry condition of all events associated with the execution condition of the candidate PSCell Cell B within T_duration1 before execution, it is likely that after or before a moment t2, the moment t2 is a moment at which the UE completes execution of CPAC to the PSCell Cell A, the Cell B meets the execution condition, and the UE needs to continue to execute CPAC to the Cell B. This is unreasonable.

However, for CHO or CHO with CPAC, that is, when the UE is configured with subsequent CPAC and CHO/CHO with CPAC at the same time, whether the UE needs to evaluate the execution condition of CHO/CHO with CPAC is also not clarified after the Cell A meets the execution condition.

CHO with CPAC is CHO with CPAC, that is, the CHO configuration information may include CPAC configuration information. For example, the CHO configuration information includes configuration information of a target MCG and configuration information of a candidate SCG for CPC/CPA.

The following describes in detail the conditional configuration information processing method provided in embodiments of this application through some embodiments and application scenarios thereof with reference to the accompanying drawings.

As shown in FIG. 3, an embodiment of this application provides a conditional configuration information processing method. The method includes the following steps.

Step 301: During execution of conditional primary secondary cell group cell addition/change CPAC, a terminal performs a first operation, where the first operation includes at least one of the following:
continuing to evaluate or stopping evaluating an execution condition associated with a candidate cell included in first conditional configuration information; and
continuing to evaluate or stopping evaluating an execution condition associated with a candidate cell included in second conditional configuration information, where
the first conditional configuration information includes CPAC configuration information and/or subsequent CPAC configuration information, and the second conditional configuration information includes conditional handover CHO configuration information and/or CHO (CHO with CPAC) configuration information with CPAC configuration information.

For example, the foregoing subsequent CPAC means that after changing a serving PSCell, the UE does not release a stored conditional configuration related parameter, and may continue to apply the stored related configuration parameter for subsequent CPA/CPC.

In this embodiment of this application, the terminal continues to evaluate the execution condition associated with the candidate cell included in first conditional configuration information, and may quickly find another candidate cell to execute CPAC when CPAC is not successfully executed this time. In addition, the UE can be helped to reduce a quantity of measurement by using a previous measurement result. The terminal stops evaluating the execution condition associated with the candidate cell included in the first conditional configuration information, so that the terminal can frequently executing CPAC, and implementation is simple.

The terminal continues to evaluate the execution condition associated with the candidate cell included in the second conditional configuration information, so that it can be ensured that a primary cell connected to UE is always a cell with good cell quality, thereby ensuring reliability of a primary connection. The terminal stops evaluating the execution condition associated with the candidate cell included in the second conditional configuration information. This helps the terminal save power, and implementation is simple.

In this embodiment of this application, during execution of CPAC, the terminal continues to evaluate or stop evaluating the execution condition associated with the candidate cell included in the first conditional configuration information, and/or continues to evaluate or stop evaluating the execution condition associated with the candidate cell included in the second conditional configuration information. This clarifies a behavior of the UE to evaluate the execution condition in the conditional configuration information during execution of CPAC.

For example, that the terminal performs the first operation includes:

The terminal performs the first operation based on a configuration of a network side device, a terminal capability, and/or a protocol predefinition.

In this embodiment of this application, the terminal determines based on the configuration of the network side device, the terminal capability, and/or the protocol agreement, whether to continue to evaluate or stop evaluating the execution condition associated with the candidate cell included in the first conditional configuration information, and/or determines to continue to evaluate or stops evaluating the execution condition associated with the candidate cell included in the second conditional configuration information.

The terminal may perform the first operation based on a network configuration information indication and/or a protocol agreement and/or a predefinition and/or a terminal implementation.

For example, the method in this embodiment of this application further includes:

During execution of conditional handover CHO or conditional handover with CPAC, the terminal stops evaluating the execution condition associated with the candidate cell included in the first conditional configuration information, and releases the first conditional configuration information. During execution of conditional handover CHO or conditional handover with CPAC, the terminal stops evaluating the execution condition associated with the candidate cell included in the first conditional configuration information, and may release the first conditional configuration information based on a network configuration information indication and/or a protocol agreement and/or a predefinition and/or a terminal implementation.

Herein, after the terminal performs CHO or CHO with CPAC, CPAC configuration information stored in the terminal is no longer valid. The UE is indicated to release the CPAC configuration information, so that the UE can be prevented from storing the invalid information. A primary secondary cell group cell included in the CPAC configuration information ensures that DC can be performed with an original PCell. However, after the UE performs CHO or CHO with CPAC, the PCell changes. Therefore, the primary secondary cell group cell may not necessarily perform DC with a changed Pcell, and the UE needs to release the CPAC configuration information.

For example, in the method in this embodiment of this application, that the terminal continues to evaluate or stops evaluating the execution condition associated with the candidate cell included in the first conditional configuration information includes:

The terminal continues to evaluate or stops evaluating the execution condition associated with the candidate cell included in the first conditional configuration information within a first time period, where
a start moment of the first time period is a first moment, and the first moment is a start moment at which the terminal executes CPAC; and
an end moment of the first time period is a second moment, and the second moment is a target moment at which the terminal successfully completes a CPAC execution procedure.

For example, the method further includes at least one of the following:
The terminal re-evaluates, at a third moment, the execution condition associated with the candidate cell included in the first conditional configuration information or updated first conditional configuration information; or
the terminal continues to evaluate, at a third moment, the execution condition associated with the candidate cell included in the first conditional configuration information, where
the third moment is the target moment, or the third moment is a moment after the target moment.

Herein, the terminal continues to evaluate, at the third moment, the execution condition associated with the candidate cell included in the first conditional configuration information, so that it can be ensured that the primary secondary cell group cell of the terminal is always a cell with good cell quality. The terminal re-evaluates, at the third moment, the execution condition associated with the candidate cell included in the first conditional configuration information or the updated first conditional configuration information, so that the terminal can be prevented from frequently executing CPAC, and this helps the terminal save power.

For example, that the terminal re-evaluates, at the third moment, the execution condition associated with the candidate cell included in the first conditional configuration information or the updated first conditional configuration information includes:

The terminal resets, at the first moment, the second moment, the third moment, evaluation duration of the candidate cell included in the first conditional configuration information, and determines that a first candidate cell included in the first conditional configuration information does not meet the execution condition, where the first candidate cell is a candidate cell in the candidate cell included in the first conditional configuration information except a second candidate cell, and the second candidate cell is a cell corresponding to CPAC executed by the terminal.

In this embodiment of this application, that the terminal resets the evaluation duration of the candidate cell includes that duration in which the terminal determines that an entry condition and/or an exit condition of an event associated with the execution condition of the candidate cell are/is met is 0. For example, for one candidate cell, when the terminal determines, at a next time, whether the terminal meets the execution condition of the candidate cell, all events associated with the execution condition corresponding to the candidate cell need to meet the entry condition within a time to trigger length associated with the candidate cell, and it is considered that the events are considered to meet the corresponding execution condition.

In an example implementation, in a subsequent CPAC process, if all events or any event associated with the candidate cell in the conditional configuration information (the first conditional configuration information or the second conditional configuration information) meet/meets the entry condition, a first timer or a timer corresponding to the event that meets the entry condition is enabled. Within running time of the enabled timer, if the event does not meet the entry condition, the timer is disabled. If the timer expires, it is considered that the candidate cell meets the execution condition. In addition, that time to trigger is set to 0 may be implemented in a manner of resetting the timer.

For example, the method in this embodiment of this application further includes at least one of the following:
determining the updated first conditional configuration information based on a radio resource control RRC reconfiguration message, where the reconfiguration message carries update information of the first conditional configuration information and/or release indication information of the first conditional configuration information; or
releasing, from the first conditional configuration information, configuration information of a candidate cell that does not meet a preset condition, to obtain the updated first conditional configuration information.

In this embodiment of this application, after completing CPAC, the terminal may receive the reconfiguration message, where the reconfiguration message carries an update message of the first conditional configuration information, and the terminal obtains the updated first conditional configuration information based on the update message.

For example, the terminal continues to evaluate or stops evaluating an execution condition associated with a candidate primary cell included in the second conditional configuration information within a first time period; and
the terminal continues to evaluate or stops evaluating an execution condition associated with a candidate primary secondary cell group cell included in the second conditional configuration information within a first time period, where
a start moment of the first time period is a first moment, and the first moment is a start moment at which the terminal executes CPAC; and
an end moment of the first time period is a second moment, and the second moment is a target moment at which the terminal successfully completes a CPAC execution procedure.

For example, the method in this embodiment of this application further includes at least one of the following:

The terminal re-evaluates or continues to evaluate, at a third moment, the execution condition associated with the candidate cell included in the second conditional configuration information, where
the third moment is the target moment, or the third moment is a moment after the target moment, and the target moment is a moment at which the terminal successfully completes a CPAC execution procedure; and
the fourth moment is a moment at which the terminal receives an RRC reconfiguration message including the updated second conditional configuration information and/or indication information including the updated second conditional configuration information.

It should be noted that the third moment in this embodiment of this application may be a moment at which the terminal successfully completes the CPAC execution procedure, or may be a moment after the target moment. For example, the third moment is T+T_wait, or the third moment may be time at which the UE successfully decodes the received RRC reconfiguration sent by the network for the first time after completing CPAC, or time at which the UE sends a response to the RRC reconfiguration.

T_wait may be protocol-agreed and/or network-indicated and/or preconfigured. A default value may be 0 or another value. A unit of T_wait is one of the following: a second(s)/millisecond (ms)/symbol/slot/subframe/frame/DRX cycle, or the like.

For example, the method in this embodiment of this application further includes:

In a case that at least one candidate cell in the second conditional configuration information meets the execution condition, the terminal executes a terminal behavior associated with the second conditional configuration information.

The terminal behavior associated with the second conditional configuration information may be CHO or CHO with CPAC.

For example, the method in this embodiment of this application further includes:

in a case that the terminal executes the terminal behavior associated with the second conditional configuration information, if the terminal is performing a CPAC operation, stopping performing the CPAC operation.

The following describes the conditional configuration information processing method in this application with reference to specific embodiments.

In a first specific embodiment of this application, a candidate cell in second conditional configuration information continues to be evaluated within first duration and at a target moment (t2). For example, the method includes the following steps.

Step 401: At a moment to, UE receives CPAC configuration information and CHO configuration information (or receives CPAC configuration information and CHO with CPAC configuration information), where the CPAC configuration information indicates that the configuration is applicable to subsequent CPAC; and the UE starts to evaluate the CPAC configuration information and whether a candidate cell in the CHO configuration information meets an execution condition associated with the candidate cell.

Step 402: At a first moment (at a moment t1), a cell A in a candidate PSCell meets the execution condition, and the UE starts to execute CPAC to change or add the Cell A to a serving cell.

The UE continues to evaluate a candidate PCell in the CHO configuration information and/or the CHO with CPAC configuration information at the moment t1; and records an evaluation status of the candidate PCell at a current moment. For example, the UE records specific duration within which each event associated with an execution condition of the candidate PCell already meets an entry condition.

If the UE receives the CHO with CPAC configuration information, for a first candidate PSCell included in the CHO with CPAC configuration information, at the moment t1, the UE continues to evaluate the first candidate PSCell; and records an evaluation status of the first candidate PSCell at a current moment. For example, the UE records specific duration within which each event associated with an execution condition of the first candidate PSCell already meets an entry condition.

Step 403: At a moment T2′, the UE does not complete a CPAC execution procedure or the UE has successfully executed CPAC, but an execution condition of a cell B in the candidate PCell of the UE has been met.

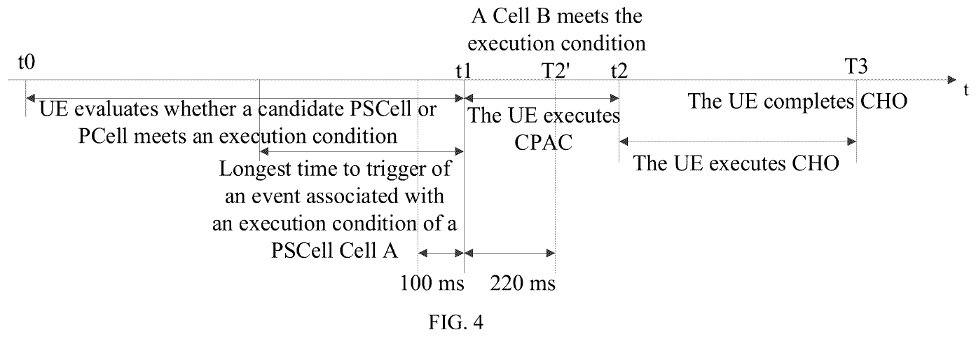

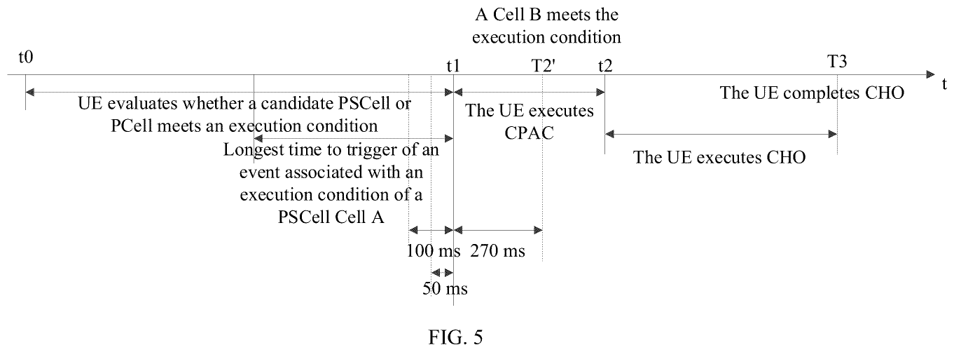

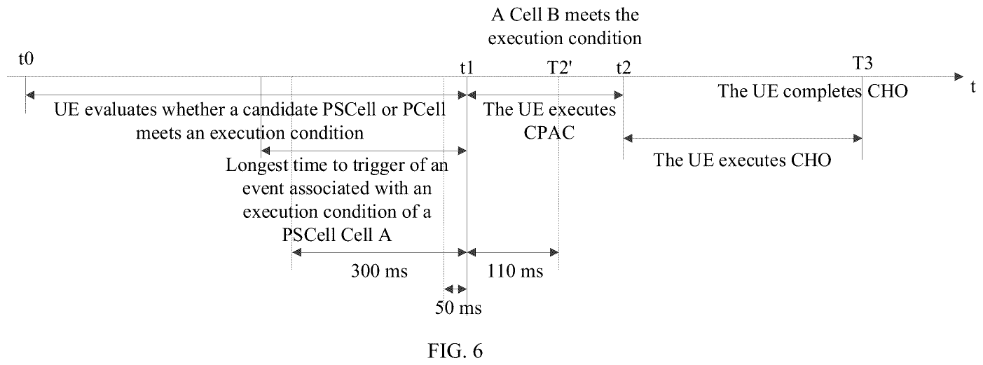

In this case, it is assumed that the event corresponding to the execution condition of the Cell B cell (it is assumed that the event corresponding to an event 1 timer to trigger: 160 ms; and that the event corresponding to an event 2 time to trigger: 320 ms) already meets the entry condition in a period of time (it is assumed that duration within which the event 1 meets the entry condition is T_duration1; and that duration within which the event 2 meets the entry condition is T_duration2). Refer to FIG. 4, FIG. 5, and FIG. 6. A possible moment T2′ is shown in Table 3.

TABLE 3

| | Event 1: | Event 2: timetotrigger | |
|---|---|---|---|
| | timetotrigger & | timetotrigger & | Minimum |
| Case | T_duration1 | T_duration2 | moment T2′ |
| Case 1 | 160 ms & 100 ms | 320 ms & 100 ms | t1 + 220 ms |
| Case 2 | 160 ms & 100 ms | 320 ms & 50 ms | t1 + 270 ms |
| Case 3 | 160 ms & 50 ms | 320 ms & 300 ms | t1 + 110 ms |

Step 404: The UE executes CHO to the candidate PCell (Cell B), and releases the stored CPAC configuration after successfully executing PCell change.

If the CHO with CPAC configuration information is configured, and if a candidate PSCell (Cell C) corresponding to the Cell B also meets the execution condition at the moment T2′, the UE performs CHO with CPAC on the Cell B and the Cell C corresponding to the Cell B, and releases the stored CPAC configuration after successfully completing the PCell change and the PSCell change steps.

In a second specific embodiment of this application, a candidate cell in second conditional configuration information stops being evaluated within first duration, and continues to be evaluated at a target moment (t2). For example, the method includes the following steps.

Step 501: At a moment t0, UE receives CPAC configuration information and CHO configuration information (or receives CPAC configuration information and CHO with CPAC configuration information), where the CPAC configuration information indicates that the configuration is applicable to subsequent CPAC; and the UE starts to evaluate whether a candidate cell in the CHO configuration information meets an execution condition associated with the candidate cell.

Step 502: At a moment t1, a candidate PSCell (Cell A) meets the execution condition; and the UE starts to execute CPAC, and adds or changes the Cell A to a serving cell, and the UE stops evaluating all candidate PCells, but the UE records an evaluation status of the candidate PCells at a current moment. For example, the UE records specific duration within which each event associated with an execution condition of the candidate PCell already meets an entry condition.

If the UE receives the CHO with CPAC configuration information, for a first candidate PSCell included in the CHO with CPAC configuration information, at the moment t1, the UE stops evaluating all first candidate PSCells, but the UE records an evaluation status of the first candidate PSCells at a current moment. For example, the UE records specific duration within which each event associated with an execution condition of the first candidate PSCell already meets an entry condition.

In this case, it is assumed that the execution condition of the candidate PCell (Cell B) corresponds to only one event, and a corresponding event already meets the entry condition within T_duration1 duration (where T_duration1<time to trigger corresponding to the event).

Step 503: At a moment t2, the UE successfully completes CPAC; and the UE starts to continue to evaluate a candidate cell in a second condition configuration. Assuming that an event associated with the execution condition of the Cell B continues to meet the entry condition at the moment t2 to a moment T2′, when the Cell B meets the execution condition at the moment T2′, the UE executes CHO to the candidate PCell (Cell B), and releases the stored CPAC configuration after successfully completing execution of PCell change.

If the CHO with CPAC configuration information is configured, and if one candidate PSCell (Cell C) corresponding to the Cell B also meets the execution condition at the moment T2′, the UE performs CHO with CPAC on the Cell B and the Cell C corresponding to the Cell B, and releases the stored CPAC configuration after successfully completing the PCell change and the PSCell change steps.

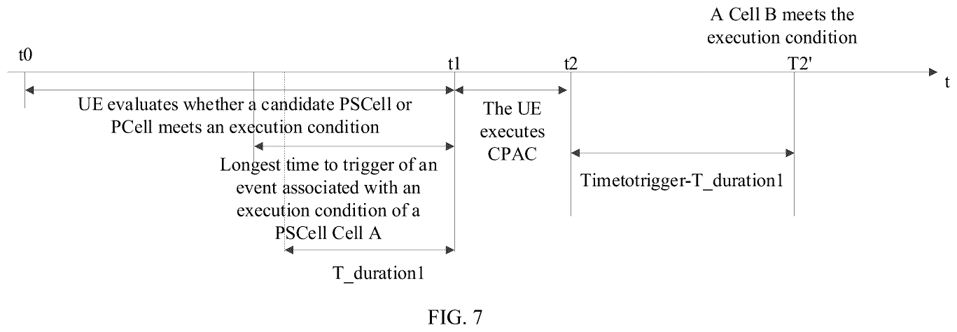

As shown in FIG. 7, a length of T2′ to t2 is Timetotrigger-T_duration1.

In a third specific embodiment of this application, a candidate cell in second conditional configuration information stops being evaluated within first duration, and is re-evaluated at a target moment (t2). For example, the method includes the following steps.

Step 601: At a moment t0, UE receives CPAC configuration information and CHO configuration information (or receives CPAC configuration information and CHO with CPAC configuration information), where the CPAC configuration information indicates that the configuration is applicable to subsequent CPAC; and the UE starts to evaluate whether a candidate cell in the CHO configuration information meets an execution condition associated with the candidate cell.

Step 602: At a moment t1, a candidate PSCell (Cell A) meets the execution condition; and the UE starts to execute CPAC, and adds or changes the Cell A to a serving cell, the UE stops evaluating all candidate PCells, and sets all other candidate PCells not to meet the execution condition, and the UE resets evaluation duration of all the candidate PCells.

If the UE receives the CHO with CPAC configuration information, for a first candidate PSCell included in the CHO with CPAC configuration information, at the moment t1, the UE stops evaluating all the first candidate PSCells, and sets all the first candidate PSCells not to meet the execution condition, and the UE resets evaluation duration of the first PSCell.

In this case, it is assumed that the execution condition of the candidate PCell (Cell B) corresponds to only one event, and a corresponding event already meets the entry condition within T_duration1 duration (where T_duration1<time to trigger corresponding to the event), and the UE does not record an evaluation status of the current execution condition of the PCell Cell B.

Step 603: At a moment t2, the UE successfully completes execution of CPAC; and the UE starts to re-evaluate the candidate cell in the second conditional configuration information. Assuming that an event associated with the execution condition of the PCell (Cell B) meets the entry condition at the moment t2 to a moment T2, the execution condition of the PCell Cell B is met at the moment T2.

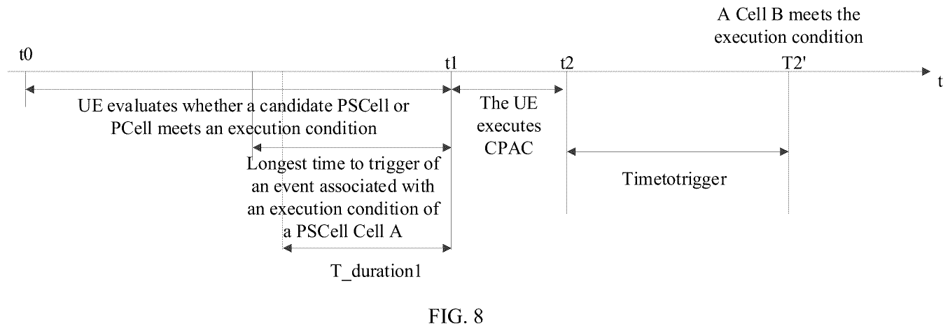

Refer to FIG. 8. A length of T2 to t2 may be Timetotrigger.

Step 604: The UE executes CHO to the candidate PCell (Cell B), and releases the stored CPAC configuration after successfully executing PCell change.

If the CHO with CPAC configuration information is configured, and if a candidate PSCell (Cell C) corresponding to the Cell B also meets the execution condition at a moment T2′, the UE performs CHO with CPAC on the Cell B and the Cell C corresponding to the Cell B, and releases the stored CPAC configuration after successfully completing the PCell change and the PSCell change steps.

In a fourth specific embodiment of this application, a candidate cell in first conditional configuration information stops being evaluated within first duration, and is re-evaluated at a target moment (t2). For example, the method includes the following steps.

Step 701: At a moment to, UE receives CPAC configuration information, where the CPAC configuration information indicates that the configuration information is applicable to subsequent CPAC; and the UE starts to evaluate whether a candidate cell in the configuration information meets an execution condition associated with the candidate cell.

Step 702: At a moment t1, a candidate PSCell (Cell A) meets the execution condition; and the UE starts to execute CPAC, and adds or changes the Cell A to a serving cell, the UE stops evaluating all candidate cells, and sets all other candidate cells not to meet the execution condition, and the UE resets evaluation duration of all the candidate PSCells.

For example, at the moment t1, the candidate PSCell (Cell C) does not meet the execution condition, but all events or one of events corresponding to the execution condition already meet/meets the entry condition within the first duration. The UE still sets the Cell C not to meet the condition, and does not record an evaluation status of the Cell B. For example, the UE resets evaluation duration of the candidate cell of the Cell C.

Each execution condition corresponds to one piece of first duration.

In another example, CPAC associated with a candidate PSCell (Cell D) also meets an execution condition at a moment t1. However, the UE selects the Cell A as a target cell, and applies a corresponding CPAC reconfiguration parameter (namely, the Cell A). The UE still sets the Cell D not to meet the condition, and does not record an evaluation status of the Cell D. For example, the UE resets evaluation duration of the candidate cell of the Cell D.

Step 703: At a moment t2, the UE successfully completes the CPAC procedure. In this case, the UE continues to evaluate an execution condition of a candidate PSCell included in CPAC.

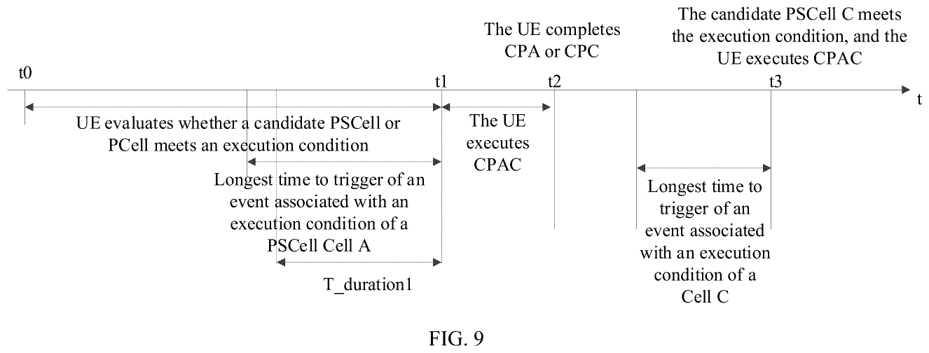

Step 704: As shown in FIG. 9, at a third moment (moment t3), if all events associated with the execution condition of the Cell C meet the entry condition within time to trigger associated with the Cell C, the Cell C meets the execution condition, the UE starts to execute CPC, and changes the PSCell from the Cell A to the Cell C, the UE stops evaluating all candidate cells, and sets all other candidate cells not to meet the execution condition, and the UE resets evaluation duration of all the candidate PSCells.

In a fifth specific embodiment of this application, a candidate cell in first conditional configuration information continues to be evaluated or stops being evaluated within first duration, and continues to be evaluated at a target moment (t2). For example, the method includes the following steps.

Step 801: At a moment to, UE receives CPAC configuration information, where the CPAC configuration information indicates that the configuration information is applicable to subsequent CPAC; and the UE starts to evaluate whether a candidate cell in the configuration information meets an execution condition associated with the candidate cell.

Step 802: A candidate PSCell (Cell A) meets the execution condition, and the UE starts to execute CPAC to add or change the Cell A to a serving cell.

In a process in which the UE executes CPAC, the UE continues to evaluate or does not evaluate another first candidate PSCell; and records an evaluation status of the another first candidate PSCell at a current moment. For example, the UE records specific duration within which each event associated with an execution condition of the another first candidate PSCell already meets an entry condition.

In a process in which the UE executes CPAC, the UE does not evaluate another second candidate PSCell; and resets evaluation duration of the candidate PSCell.

The another first candidate PSCell includes a candidate cell whose execution condition is an event A4 and/or an event B1 or all other candidate cells.

The another second candidate PSCell includes a candidate cell whose execution condition is an event A3 and/or an event A5 or all other candidate cells. If during execution of CPAC, another candidate PSCell meets a condition, but original CPAC of the UE fails, the UE continues to execute CPAC; and otherwise, the UE selects the another candidate PSCell that meets the condition to re-execute CPAC.

Step 803: If the UE successfully completes CPAC, the UE continues to evaluate the execution condition of the another first candidate PSCell, and re-evaluates the execution condition of the another second candidate PSCell.

For example, for another third candidate PSCell, after the UE completes one time of CPAC, CPAC is allowed to be re-executed or is allowed to be re-evaluated or continue to be evaluated only after camping exceeds second duration. The another third candidate PSCell includes any one of the following:
the another first candidate PSCell;
all candidate PSCells, except the Cell A, included in the CPAC configuration information;
all candidate PSCells included in the CPAC configuration information; and
a candidate PSCell, in the conditional configuration information, that already meets the condition before the UE successfully completes execution of CPAC.

The second duration is protocol-agreed and/or network-configured and/or predefined.

In a sixth specific embodiment of this application, a candidate cell in first conditional configuration information stops being evaluated within first duration, and continues to be evaluated at a target third moment (t2). For example, the method includes the following steps.

Step 901: At a moment to, UE receives CPAC configuration information, where the CPAC configuration information indicates that the configuration information is applicable to subsequent CPAC; and the UE starts to evaluate whether a candidate cell in the configuration information meets an execution condition associated with the candidate cell.

Step 902: At a moment t1, a candidate PSCell (Cell A) meets the execution condition, and the UE starts to execute CPAC to add or change the Cell A to a serving cell.

In a process in which the UE executes CPAC, the UE stops evaluating another candidate PSCell, but the UE records an evaluation status of the PSCell at a current moment.

Step 903: If the UE successfully completes execution of CPAC, the UE continues to evaluate the execution condition of the another candidate PSCell, and re-evaluates an execution condition of another non-first candidate PSCell.

For example, after the UE completes one time of CPAC, CPAC is allowed to be re-executed or the candidate PSCell continues to be evaluated only after camping exceeds second duration.

In this embodiment of this application, during execution of CPAC, the terminal continues to evaluate or stop evaluating the execution condition associated with the candidate cell included in the first conditional configuration information, and/or continues to evaluate or stop evaluating the execution condition associated with the candidate cell included in the second conditional configuration information. This clarifies a behavior of the UE to evaluate the execution condition in the conditional configuration information during execution of CPAC.

The conditional configuration information processing method provided in embodiments of this application may be performed by a conditional configuration information processing apparatus. In embodiments of this application, an example in which the conditional configuration information processing apparatus performs the conditional configuration information processing method is used, to describe the conditional configuration information processing apparatus provided in embodiments of this application.

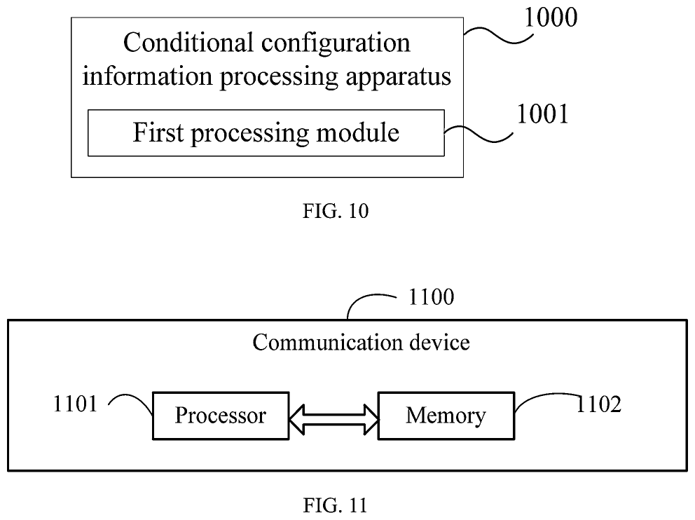

As shown in FIG. 10, an embodiment of this application further provides a conditional configuration information processing apparatus 1000, used in a terminal. The apparatus includes:
a first processing module 1001, configured to: during execution of conditional primary secondary cell group cell addition/change CPAC, perform a first operation, where the first operation includes at least one of the following:
continuing to evaluate or stopping evaluating an execution condition associated with a candidate cell included in first conditional configuration information; and
continuing to evaluate or stopping evaluating an execution condition associated with a candidate cell included in second conditional configuration information, where
the first conditional configuration information includes CPAC configuration information and/or subsequent CPAC configuration information, and the second conditional configuration information includes conditional handover CHO configuration information and/or CHO configuration information with CPAC configuration information.

For example, the first processing module is configured to perform the first operation based on a configuration of a network side device, a terminal capability, and/or a protocol predefinition.

For example, the apparatus in this embodiment of this application further includes: a second processing module, configured to: during execution of conditional handover CHO or conditional handover with CPAC, stop evaluating the execution condition associated with the candidate cell included in the first conditional configuration information, and release the first conditional configuration information.

For example, the first processing module is configured to continue to evaluate or stop evaluating the execution condition associated with the candidate cell included in the first conditional configuration information within a first time period, where
a start moment of the first time period is a first moment, and the first moment is a start moment at which the terminal executes CPAC; and
an end moment of the first time period is a second moment, and the second moment is a target moment at which the terminal successfully completes a CPAC execution procedure.

For example, the apparatus in this embodiment of this application further includes:
a third processing module, configured to perform at least one of the following:
re-evaluating, at a third moment, the execution condition associated with the candidate cell included in the first conditional configuration information or updated first conditional configuration information; or
continuing to evaluate, at a third moment, the execution condition associated with the candidate cell included in the first conditional configuration information, where
the third moment is the target moment, or the third moment is a moment after the target moment.

For example, the third processing module is configured to reset, at the first moment, the second moment, or the third moment, evaluation duration of the candidate cell included in the first conditional configuration information, and determine that a first candidate cell included in the first conditional configuration information does not meet the execution condition, where the first candidate cell is a candidate cell in the candidate cell included in the first conditional configuration information except a second candidate cell, and the second candidate cell is a cell corresponding to CPAC executed by the terminal.

For example, the third processing module is configured to determine that duration meeting a first condition is 0, where

the first condition includes at least one of an entry condition and an exit condition of an event associated with the execution condition of the candidate cell.

For example, the apparatus in this embodiment of this application further includes:
a first determining module, configured to perform at least one of the following:
determining the updated first conditional configuration information based on an RRC reconfiguration message, where the RRC reconfiguration message carries update information of the first conditional configuration information and/or release indication information of the first conditional configuration information; or
releasing, from the first conditional configuration information, configuration information of a candidate cell that does not meet a preset condition, to obtain the updated first conditional configuration information.

For example, the first processing module is configured to perform at least one of following:
continuing to evaluate or stopping evaluating an execution condition associated with a candidate primary cell included in the second conditional configuration information within a first time period; and
continuing to evaluate or stopping evaluating an execution condition associated with a candidate primary secondary cell group cell included in the second conditional configuration information within a first time period, where
a start moment of the first time period is a first moment, and the first moment is a start moment at which the terminal executes CPAC; and
an end moment of the first time period is a second moment, and the second moment is a target moment at which the terminal successfully completes a CPAC execution procedure.

For example, the apparatus in this embodiment of this application further includes:
a fourth processing module, configured to perform at least one of the following:
re-evaluating or continuing to, at a third moment, evaluate the execution condition associated with the candidate cell included in the second conditional configuration information, where
the third moment is the target moment, or the third moment is a moment after the target moment, and the target moment is a moment at which the terminal successfully completes a CPAC execution procedure; and
the fourth moment is a moment at which the terminal receives an RRC reconfiguration message including the updated second conditional configuration information and/or indication information including the updated second conditional configuration information.

For example, the apparatus in this embodiment of this application further includes:

a fifth processing module, configured to: in a case that at least one candidate cell in the second conditional configuration information meets the execution condition, execute a terminal behavior associated with the second conditional configuration information.

For example, the apparatus in this embodiment of this application further includes:

a sixth processing module, configured to: in a case that the terminal executes the terminal behavior associated with the second conditional configuration information, if the terminal is performing a CPAC operation, stop performing the CPAC operation.

In this embodiment of this application, during execution of CPAC, the terminal continues to evaluate or stop evaluating the execution condition associated with the candidate cell included in the first conditional configuration information, and/or continues to evaluate or stop evaluating the execution condition associated with the candidate cell included in the second conditional configuration information. This clarifies a behavior of UE to evaluate the execution condition in the conditional configuration information during execution of CPAC.

The conditional configuration information processing apparatus in this embodiment of this application may be an electronic device, for example, an electronic device with an operating system, or may be a component, for example, an integrated circuit or a chip, in the electronic device. The electronic device may be a terminal, or may be a device other than the terminal. For example, the terminal may include but is not limited to the foregoing listed types of the terminal 11. The another device may be a server, a Network Attached Storage (NAS), or the like. This is not specifically limited in this embodiment of this application.

The conditional configuration information processing apparatus provided in this embodiment of this application can implement the processes implemented in the method embodiments from FIG. 3 to FIG. 9, and same technical effect can be achieved. To avoid repetition, details are not described herein again.

For example, as shown in FIG. 11, an embodiment of this application further provides a communication device 1100. The communication device 1100 includes a processor 1101 and a memory 1102. The memory 1102 stores a program or an instruction that can be run on the processor 1101. For example, when the communication device 1100 is a terminal, the program or the instruction is executed by the processor 1101 to implement steps of the foregoing conditional configuration information processing method embodiments, and same technical effect can be achieved. To avoid repetition, details are not described herein again.

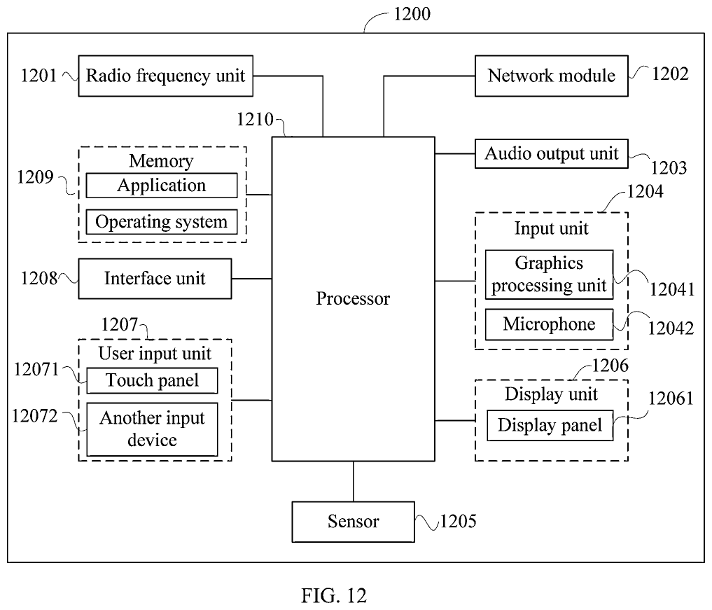

An embodiment of this application further provides a terminal. The terminal includes a processor and a communication interface. The processor is configured to: during execution of conditional primary secondary cell group cell addition/change CPAC, perform a first operation, where the first operation includes at least one of the following:
continuing to evaluate or stopping evaluating an execution condition associated with a candidate cell included in first conditional configuration information; and
continuing to evaluate or stopping evaluating an execution condition associated with a candidate cell included in second conditional configuration information, where
the first conditional configuration information includes CPAC configuration information and/or subsequent CPAC configuration information, and the second conditional configuration information includes conditional handover CHO configuration information and/or CHO configuration information with CPAC configuration information. This terminal embodiment corresponds to the foregoing method embodiment on the terminal side, each implementation process and implementation of the foregoing method embodiment can be applied to this terminal embodiment, and same technical effect can be achieved. For example, FIG. 12 is a schematic diagram of a hardware structure of a terminal according to an embodiment of this application.

The terminal 1200 includes but is not limited to at least a part of components such as a radio frequency unit 1201, a network module 1202, an audio output unit 1203, an input unit 1204, a sensor 1205, a display unit 1206, a user input unit 1207, an interface unit 1208, a memory 1209, and a processor 1210.

A person skilled in the art can understand that the terminal 1200 may further include a power supply (such as a battery) that supplies power to each component. The power supply may be logically connected to the processor 1210 by using a power supply management system, to implement functions such as charging and discharging management, and power consumption management by using the power supply management system. The structure of the terminal shown in FIG. 12 does not constitute a limitation on the terminal. The terminal may include more or fewer components than those shown in the figure, or combine some components, or have different component arrangements. Details are not described herein.

It should be understood that in this embodiment of this application, the input unit 1204 may include a Graphics Processing Unit (GPU) 12041 and a microphone 12042. The graphics processing unit 12041 processes image data of a static picture or a video obtained by an image capture apparatus (for example, a camera) in a video capture mode or an image capture mode. The display unit 1206 may include a display panel 12061, and the display panel 12061 may be configured in a form of a liquid crystal display, an organic light-emitting diode, or the like. The user input unit 1207 includes at least one of a touch panel 12071 and another input device 12072. The touch panel 12071 is also referred to as a touchscreen. The touch panel 12071 may include two parts: a touch detection apparatus and a touch controller. The another input device 12072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 1201 may transmit the downlink data to the processor 1210 for processing. In addition, the radio frequency unit 1201 may send uplink data to the network side device. Usually, the radio frequency unit 1201 includes but is not limited to an antenna, an amplifier, a transceiver, a coupler, a low noise amplifier, a duplexer, and the like.

The memory 1209 may be configured to store a software program or an instruction and various data. The memory 1209 may mainly include a first storage area for storing a program or an instruction and a second storage area for storing data. The first storage area may store an operating system, and an application or an instruction required by at least one function (for example, a sound playing function or an image playing function). In addition, the memory 1209 may be a volatile memory or a non-volatile memory, or the memory 1209 may include a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch link DRAM (SLDRAM), and a Direct Rambus RAM (DRRAM). The memory 1209 in this embodiment of this application includes but is not limited to these memories and any memory of another proper type.

The processor 1210 may include one or more processing units. For example, an application processor and a modem processor are integrated into the processor 1210. The application processor mainly processes an operating system, a user interface, an application, and the like. The modem processor mainly processes a wireless communication signal, for example, a baseband processor. It may be understood that, in some embodiments, the modem processor may not be integrated into the processor 1210.

The processor 1210 is configured to: during execution of conditional primary secondary cell group cell addition/change CPAC, perform a first operation, where the first operation includes at least one of the following:
continuing to evaluate or stopping evaluating an execution condition associated with a candidate cell included in first conditional configuration information; and
continuing to evaluate or stopping evaluating an execution condition associated with a candidate cell included in second conditional configuration information, where
the first conditional configuration information includes CPAC configuration information and/or subsequent CPAC configuration information, and the second conditional configuration information includes conditional handover CHO configuration information and/or CHO configuration information with CPAC configuration information.

In this embodiment of this application, during execution of CPAC, the terminal continues to evaluate or stop evaluating the execution condition associated with the candidate cell included in the first conditional configuration information, and/or continues to evaluate or stop evaluating the execution condition associated with the candidate cell included in the second conditional configuration information. This clarifies a behavior of UE to evaluate the execution condition in the conditional configuration information during execution of CPAC.

For example, the processor 1210 is further configured to perform the first operation based on a configuration of a network side device, a terminal capability, or a protocol predefinition.

For example, the processor 1210 is further configured to: during execution of conditional handover CHO or conditional handover with CPAC, stop evaluating the execution condition associated with the candidate cell included in the first conditional configuration information, and release the first conditional configuration information.

For example, the processor 1210 is further configured to continue to evaluate or stop evaluating the execution condition associated with the candidate cell included in the first conditional configuration information within a first time period, where
a start moment of the first time period is a first moment, and the first moment is a start moment at which the terminal executes CPAC; and
an end moment of the first time period is a second moment, and the second moment is a target moment at which the terminal completes CPAC.

For example, the processor 1210 is further configured to perform at least one of the following:
The terminal re-evaluates, at a third moment, the execution condition associated with the candidate cell included in the first conditional configuration information or updated first conditional configuration information; or
the terminal continues to evaluate, at a third moment, the execution condition associated with the candidate cell included in the first conditional configuration information, where
the third moment is the target moment, or the third moment is a moment after the target moment.

For example, the processor 1210 is further configured to reset, at the first moment, the second moment, or the third moment, evaluation duration of the candidate cell included in the first conditional configuration information, and determine that a first candidate cell included in the first conditional configuration information does not meet the execution condition, where the first candidate cell is a candidate cell in the candidate cell included in the first conditional configuration information except a second candidate cell, and the second candidate cell is a cell corresponding to CPAC executed by the terminal.

For example, the processor 1210 is further configured to determine the updated first conditional configuration information based on a reconfiguration message, where the reconfiguration message carries update information of the first conditional configuration information; or

release, from the first conditional configuration information, configuration information of a candidate cell that does not meet a preset condition, to obtain the updated first conditional configuration information.

For example, the processor 1210 is further configured to perform at least one of the following:
continuing to evaluate or stopping evaluating an execution condition associated with a candidate primary cell included in the second conditional configuration information within a first time period; and
continuing to evaluate or stopping evaluating an execution condition associated with a candidate primary secondary cell group cell included in the second conditional configuration information within the first time period, where
the first moment is a start moment at which the terminal executes CPAC.

For example, the processor 1210 is further configured to re-evaluate or continue to evaluate, at a third moment, the execution condition associated with the candidate cell included in the second conditional configuration information, where

the third moment is the target moment, or the third moment is a moment after the target moment, and the target moment is a moment at which the terminal completes CPAC.

For example, the processor 1210 is further configured to: in a case that at least one candidate cell in the second conditional configuration information meets the execution condition, execute a terminal behavior associated with the second conditional configuration information.

For example, the processor 1210 is further configured to: in a case that the terminal executes the terminal behavior associated with the second conditional configuration information, if the terminal is performing a CPAC operation, stop performing the CPAC operation.

In this embodiment of this application, during execution of CPAC, the terminal continues to evaluate or stop evaluating the execution condition associated with the candidate cell included in the first conditional configuration information, and/or continues to evaluate or stop evaluating the execution condition associated with the candidate cell included in the second conditional configuration information. This clarifies a behavior of UE to evaluate the execution condition in the conditional configuration information during execution of CPAC.

An embodiment of this application further provides a readable storage medium. The readable storage medium stores a program or an instruction. When the program or the instruction is executed by a processor, processes of the foregoing conditional configuration information processing method embodiments are implemented, and same technical effect can be achieved. To avoid repetition, details are not described herein again.

The processor is a processor in the terminal in the foregoing embodiments. The readable storage medium includes a computer-readable storage medium, for example, a computer read-only memory ROM, a random access memory RAM, a magnetic disk, or an optical disc.

An embodiment of this application further provides a chip. The chip includes a processor and a communication interface, the communication interface is coupled to the processor, the processor is configured to run a program or an instruction, to implement the foregoing conditional configuration information processing method embodiments, and same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product. The computer program/program product is stored in a storage medium, the computer program/program product is executed by at least one processor, to implement the foregoing conditional configuration information processing method embodiments, and same technical effect can be achieved. To avoid repetition, details are not described herein again.

A person of ordinary skill in the art may be aware that, in combination with the examples described in embodiments disclosed in this specification, units and algorithm steps may be implemented by electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the scope of this application.

It can be clearly understood by a person skilled in the art that, for the purpose of convenient and brief description, for a detailed operating process of the foregoing system, apparatus, and unit, refer to a corresponding process in the foregoing method embodiments. Details are not described herein again.

In embodiments provided in this application, it should be understood that the disclosed apparatus and method may be implemented in other manners. For example, the described apparatus embodiments are merely examples. For example, division into the units is merely logical function division and may be other division during actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electrical, mechanical, or other forms.

The units described as separate parts may or may not be physically separate, and parts displayed as units may or may not be physical units, that is, may be located in one place, or may be distributed on a plurality of network units. Some or all of the units may be selected based on actual requirements to achieve the objectives of the solutions in embodiments.

In addition, functional units in embodiments of this application may be integrated into one processing unit, or each of the units may exist alone physically, or two or more units may be integrated into one unit.

When the functions are implemented in a form of a software functional unit and sold or used as an independent product, the functions may be stored in a computer-readable storage medium. Based on such an understanding, the technical solutions of this application essentially, or the part contributing to the conventional technology, or some of the technical solutions may be implemented in a form of a software product. The computer software product is stored in a storage medium, and includes several instructions for instructing a computer device (which may be a personal computer, a server, a network device, or the like) to perform all or some of the steps of the methods described in embodiments of this application. The foregoing storage medium includes any medium that can store program code, such as a USB flash drive, a removable hard disk, a ROM, a RAM, a magnetic disk, or an optical disc.

A person of ordinary skill in the art may understand that all or some of the procedures of the methods in embodiments may be implemented by a computer program controlling related hardware. The program may be stored in a computer-readable storage medium. When the program is run, the procedures of the methods in embodiments are performed. The foregoing storage medium may be a magnetic disk, an optical disc, a Read-Only Memory (ROM), a Random Access Memory (RAM), or the like.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements that are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the method and the apparatus in embodiments of this application is not limited to performing functions in an illustrated or discussed sequence, and may also include performing functions in a basically simultaneous manner or in a reverse sequence based on the functions concerned. For example, the described method may be performed in an order different from the described order, and the steps may be added, omitted, or combined. In addition, features described with reference to some examples may be combined in other examples.

Based on the descriptions of the foregoing implementations, a person skilled in the art may clearly understand that the method in the foregoing embodiments may be implemented by software in addition to a necessary universal hardware platform or by hardware only. In most circumstances, the former is an example implementation. Based on such an understanding, the technical solutions of this application essentially or the part contributing to the related art may be implemented in a form of a computer software product. The computer software product is stored in a storage medium (for example, a ROM/RAM, a hard disk, or an optical disc), and includes several instructions for instructing a terminal (which may be a mobile phone, a computer, a server, an air conditioner, a network device, or the like) to perform the method described in embodiments of this application.

Embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms without departing from the purpose of this application and the protection scope of the claims, all of the forms fall within the protection of this application.

1. A conditional configuration information processing method, comprising:
during execution of Conditional Primary Secondary Cell Group Cell Addition/Change (CPAC), performing, by a terminal, a first operation, wherein the first operation comprises at least one of the following:
continuing to evaluate or stopping evaluating an execution condition associated with a candidate cell comprised in first conditional configuration information; or
continuing to evaluate or stopping evaluating an execution condition associated with a candidate cell comprised in second conditional configuration information, wherein
the first conditional configuration information comprises CPAC configuration information or subsequent CPAC configuration information, the second conditional configuration information comprises Conditional Handover (CHO) configuration information or CHO configuration information with CPAC configuration information.

2. The conditional configuration information processing method according to claim 1, wherein the performing, by the terminal, the first operation comprises:
performing, by the terminal, the first operation based on a configuration of a network side device, a terminal capability, or a protocol predefinition.

3. The conditional configuration information processing method according to claim 1, further comprising:
during execution of CHO or CHO with CPAC, stopping, by the terminal, evaluating the execution condition associated with the candidate cell comprised in the first conditional configuration information, and releasing the first conditional configuration information.

4. The conditional configuration information processing method according to claim 1, wherein the continuing to evaluate or stopping evaluating the execution condition associated with the candidate cell comprised in the first conditional configuration information comprises:
continuing to evaluate or stopping evaluating, by the terminal, the execution condition associated with the candidate cell comprised in the first conditional configuration information within a first time period, wherein
a start moment of the first time period is a first moment, the first moment is a start moment at which the terminal executes CPAC,
wherein an end moment of the first time period is a second moment, the second moment is a target moment at which the terminal successfully completes a CPAC execution procedure.

5. The conditional configuration information processing method according to claim 4, further comprising at least one of the following:
re-evaluating, by the terminal at a third moment, the execution condition associated with the candidate cell comprised in the first conditional configuration information or updated first conditional configuration information; or
continuing to evaluate, by the terminal at a third moment, the execution condition associated with the candidate cell comprised in the first conditional configuration information, wherein
the third moment is the target moment, or the third moment is a moment after the target moment.

6. The conditional configuration information processing method according to claim 5, wherein the re-evaluating, by the terminal at the third moment, the execution condition associated with the candidate cell comprised in the first conditional configuration information or updated first conditional configuration information comprises:
resetting, by the terminal at the first moment, the second moment, or the third moment, evaluation duration of the candidate cell comprised in the first conditional configuration information, and determining that a first candidate cell comprised in the first conditional configuration information does not meet the execution condition, wherein the first candidate cell is a candidate cell in the candidate cell comprised in the first conditional configuration information except a second candidate cell, the second candidate cell is a cell corresponding to CPAC executed by the terminal.

7. The conditional configuration information processing method according to claim 6, wherein the resetting evaluation duration of the candidate cell comprised in the first conditional configuration information comprises:
determining, by the terminal, that duration meeting a first condition is 0, wherein
the first condition comprises at least one of an entry condition or an exit condition of an event associated with the execution condition of the candidate cell.

8. The conditional configuration information processing method according to claim 5, further comprising at least one of the following:
determining the updated first conditional configuration information based on a Radio Resource Control (RRC) reconfiguration message, wherein the RRC reconfiguration message carries update information of the first conditional configuration information or release indication information of the first conditional configuration information; or
releasing, from the first conditional configuration information, configuration information of a candidate cell that does not meet a preset condition, to obtain the updated first conditional configuration information.

9. The conditional configuration information processing method according to claim 1, wherein the continuing to evaluate or stopping evaluating the execution condition associated with the candidate cell comprised in the second conditional configuration information comprises at least one of the following:
continuing to evaluate or stopping evaluating, by the terminal, an execution condition associated with a candidate primary cell comprised in the second conditional configuration information within a first time period; or
continuing to evaluate or stopping evaluating, by the terminal, an execution condition associated with a candidate primary secondary cell group cell comprised in the second conditional configuration information within a first time period, wherein
a start moment of the first time period is a first moment, and the first moment is a start moment at which the terminal executes CPAC,
wherein an end moment of the first time period is a second moment, and the second moment is a target moment at which the terminal successfully completes a CPAC execution procedure.

10. The conditional configuration information processing method according to claim 9, further comprising at least one of the following:
re-evaluating or continuing to evaluate, by the terminal at a third moment, the execution condition associated with the candidate cell comprised in the second conditional configuration information; or
re-evaluating, by the terminal at a fourth moment, an execution condition associated with a candidate cell comprised in updated second conditional configuration information, wherein
the third moment is the target moment, or the third moment is a moment after the target moment, the target moment is a moment at which the terminal successfully completes a CPAC execution procedure,
wherein the fourth moment is a moment at which the terminal receives an RRC reconfiguration message comprising the updated second conditional configuration information or indication information comprising the updated second conditional configuration information.

11. The conditional configuration information processing method according to claim 9, further comprising:
when at least one candidate cell in the second conditional configuration information meets the execution condition, executing, by the terminal, a terminal behavior associated with the second conditional configuration information.

12. The conditional configuration information processing method according to claim 10, further comprising:
when at least one candidate cell in the second conditional configuration information meets the execution condition, executing, by the terminal, a terminal behavior associated with the second conditional configuration information.

13. The conditional configuration information processing method according to claim 11, further comprising:
when the terminal executes the terminal behavior associated with the second conditional configuration information, in response to the terminal being performing a CPAC operation, stopping performing the CPAC operation.

14. A terminal, comprising a processor and a memory storing instructions, wherein the instructions, when executed by the processor, cause the processor to perform operations comprising:
during execution of Conditional Primary Secondary Cell Group Cell Addition/Change (CPAC), performing a first operation, wherein the first operation comprises at least one of the following:
continuing to evaluate or stopping evaluating an execution condition associated with a candidate cell comprised in first conditional configuration information; or
continuing to evaluate or stopping evaluating an execution condition associated with a candidate cell comprised in second conditional configuration information, wherein
the first conditional configuration information comprises CPAC configuration information or subsequent CPAC configuration information, the second conditional configuration information comprises Conditional Handover (CHO) configuration information or CHO configuration information with CPAC configuration information.

15. The terminal according to claim 14, wherein the performing the first operation comprises:
performing the first operation based on a configuration of a network side device, a terminal capability, or a protocol predefinition.

16. The terminal according to claim 14, wherein the continuing to evaluate or stopping evaluating the execution condition associated with the candidate cell comprised in the first conditional configuration information comprises:
continuing to evaluate or stopping evaluating the execution condition associated with the candidate cell comprised in the first conditional configuration information within a first time period, wherein
a start moment of the first time period is a first moment, and the first moment is a start moment at which the terminal executes CPAC,
wherein an end moment of the first time period is a second moment, the second moment is a target moment at which the terminal successfully completes a CPAC execution procedure.

17. The terminal according to claim 16, wherein the instructions, when executed by the processor, cause the processor to further perform operations comprising at least one of the following:
re-evaluating the execution condition associated with the candidate cell comprised in the first conditional configuration information or updated first conditional configuration information at a third moment; or
continuing to evaluate the execution condition associated with the candidate cell comprised in the first conditional configuration information at a third moment, wherein
the third moment is the target moment, or the third moment is a moment after the target moment.

18. A non-transitory computer readable storage medium storing instructions that, when executed by a processor of a terminal, cause the processor to perform operations comprising:
during execution of Conditional Primary Secondary Cell Group Cell Addition/Change (CPAC), performing a first operation, wherein the first operation comprises at least one of the following:
continuing to evaluate or stopping evaluating an execution condition associated with a candidate cell comprised in first conditional configuration information; or
continuing to evaluate or stopping evaluating an execution condition associated with a candidate cell comprised in second conditional configuration information, wherein
the first conditional configuration information comprises CPAC configuration information or subsequent CPAC configuration information, the second conditional configuration information comprises Conditional Handover (CHO) configuration information or CHO configuration information with CPAC configuration information.

19. The non-transitory computer readable storage medium according to claim 17, wherein the continuing to evaluate or stopping evaluating the execution condition associated with the candidate cell comprised in the first conditional configuration information comprises:
continuing to evaluate or stopping evaluating the execution condition associated with the candidate cell comprised in the first conditional configuration information within a first time period, wherein
a start moment of the first time period is a first moment, the first moment is a start moment at which the terminal executes CPAC,
wherein an end moment of the first time period is a second moment, the second moment is a target moment at which the terminal successfully completes a CPAC execution procedure.

20. The non-transitory computer readable storage medium according to claim 18, wherein when the instructions are executed by a processor of the terminal, cause the processor to further perform operations comprising:
re-evaluating the execution condition associated with the candidate cell comprised in the first conditional configuration information or updated first conditional configuration information at a third moment; or
continuing to evaluate the execution condition associated with the candidate cell comprised in the first conditional configuration information at a third moment, wherein
the third moment is the target moment, or the third moment is a moment after the target moment.
